(19) United States
(12) Patent Application Publication
(10) Pub. No.: US 2009/0210265 A1
(43) Pub. Date: Aug. 20, 2009

(54) Promoting Sales Of An Establishment

(76) Inventor: David Rascon Ortiz, Bradford (GB)

Correspondence Address: Ashok Tankha, 36 Greenleigh Drive, Sewell, NJ, 08080, US

(21) Appl. No.: 12/031,723

(22) Filed: Feb. 15, 2008

(51) Int. Cl. G06Q 30/00; G06Q 10/00

(52) U.S. Cl. 705/7; 705/14

(57) ABSTRACT

Disclosed herein is a computer implemented method and system for promoting sales through a customer incentive scheme of an establishment. The establishment offers the customer a redeemable voucher of a first value on purchase of merchandise. The customer registers the redeemable voucher on an online website. The online website is managed by a promotion company. The promotion company places the customer in a promotion cycle on the online website. The promotion cycle comprises a predetermined sequence of redeeming registered vouchers of the customer and multiple registered customers. The promotion company tracks total value accumulated by the customer on the online website till the total value reaches an exchange value predetermined by the establishment and the promotion company. The customer then redeems the redeemable voucher for the exchange value for merchandise from the establishment or a company participating in the customer incentive scheme.

### BACKGROUND

This invention, in general, relates to promoting sales of establishments. More particularly, this invention relates to promoting sales through a customer incentive scheme of an establishment.

Companies engage sales and marketing strategies at the expense of man power resources. For example, marketing strategies including direct marketing and targeted advertising may be accomplished using large sales and marketing teams by the companies. The sales and marketing strategies include providing customers incentive offers on purchase of goods or services. Incentive providers may offer incentives to the customers directly through a purchase discount or coupons. Moreover, the incentive providers may offer the incentives to the customers by forsaking a large portion of the sales profit. Furthermore, the incentives provided to the customer by a shop or a company may not increase the purchasing power of the customer.

Hence, there is a need for a method and system to promote sales through a customer incentive scheme of an establishment in order to increase the purchasing power of the customer and the sales of the establishment.

### SUMMARY OF THE INVENTION

The computer implemented method and system disclosed herein addresses the need for promoting sales through a customer incentive scheme of an establishment.

An establishment offers a customer a redeemable voucher of a first value on purchase of merchandise through a customer incentive scheme of the establishment. The customer incentive scheme may be provided to the establishment by a promotion company. The establishment includes companies, shops and retail stores, service providers, online stores, or restaurants. The redeemable voucher includes a voucher number, website address of the promotion company, the first value of the redeemable voucher, exchange value upon completion of a promotion cycle, a predetermined value of the fee charged by the promotion company, promotion cycle instructions to the customer, and advertisements. The customer registers the redeemable voucher on an online website managed by the promotion company. The promotion company places the customer in a promotion cycle on registration of the redeemable voucher on the online website. The promotion cycle comprises a predetermined sequence of redeeming registered vouchers of the customer and multiple registered customers.

The promotion company tracks total value accumulated by the customer on the online website till the total value reaches an exchange value predetermined by the establishment and the promotion company. The total value is the sum of first values of the registered vouchers of the registered customers. Further, the customer redeems the redeemable voucher for the exchange value. The exchange value is determined by the establishment and the promotion company. The customer exchanges the redeemable voucher for merchandise. The customer may redeem the redeemable voucher at the establishment or companies participating in the customer service scheme. The promotion company charges the establishment a scheme service fee and the customer a customer service fee for the services provided.

Redeeming the voucher provided by the customer incentive scheme increases the purchasing power of the customer. Moreover, the establishment benefits through the increased sale of merchandise. Furthermore, the promotion company benefits through the service charges levied on the establishment and the customer for the services offered.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of promoting sales through a customer incentive scheme of an establishment.

FIG. 2 exemplarily illustrates the customer incentive scheme implemented by the establishment and the promotion company.

FIG. 3 exemplarily illustrates the promotion cycle of the customer incentive scheme.

FIG. 4 exemplarily illustrates an “early withdraw option” provided to the customer in the customer incentive scheme.

FIG. 5 exemplarily illustrates the process flow of the promotion of sales through the customer incentive scheme of the establishment.

FIG. 6 exemplarily illustrates the monetary transaction flow in the customer incentive scheme.

FIG. 7 illustrates a computer implemented system for promoting sales through a customer incentive scheme of an establishment.

### DETAILED DESCRIPTION OF THE INVENTION

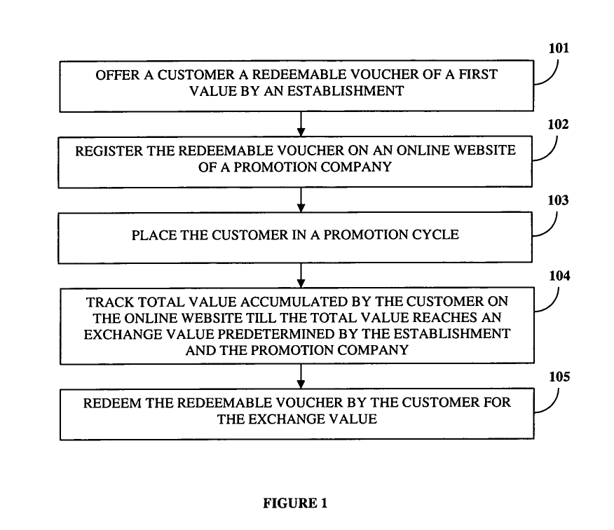

FIG. 1 illustrates a computer implemented method of promoting sales through a customer incentive scheme of an establishment 202. The establishment 202 offers 101 a customer 203, a redeemable voucher of a first value on purchase of merchandise through a customer incentive scheme of the establishment 202. The customer incentive scheme may be provided to the establishment 202 by a promotion company 200. The establishment 202 includes companies, shops and retail stores, service providers, online stores, or restaurants. The redeemable voucher includes a voucher number, website address of the promotion company 200, the first value of the redeemable voucher, exchange value upon completion of a promotion cycle, a predetermined value of the fee charged by the promotion company 200, promotion cycle instructions to the customer 203, and advertisements. The customer 203 registers 102 the redeemable voucher on an online website 500 managed by the promotion company 200. The promotion company 200 places 103 the customer 203 in a promotion cycle on registration of the redeemable voucher on the online website 500. The promotion cycle comprises a predetermined sequence of redeeming registered vouchers of the customer 203 and multiple registered customers.

The promotion company 200 tracks 104 total value accumulated by the customer 203 on the online website 500 till the total value reaches an exchange value predetermined by the establishment 202 and the promotion company 200. The total value is the sum of first values of the registered vouchers of the registered customers. Further, the total value depends on number of registered vouchers and may have a value depending on the number of registered customers. The customer 203 then redeems 105 the redeemable voucher for the exchange value. The exchange value is determined by the establishment 202 and the promotion company 200. The promotion company 200 may charge the customer 203 a customer service fee based on one or more of type of company issuing the redeemable voucher, season of the year, or current market rate. The customer 203 may then exchange the redeemable voucher for merchandise. The customer 203 may redeem the redeemable voucher at the establishment 202 or companies participating in the customer service scheme. The redeemable voucher may be exchanged for merchandise at an exchange value after deducting the customer service fee from the exchange value. The promotion company 200 may also charge the establishment 202 a scheme service fee for services provided.

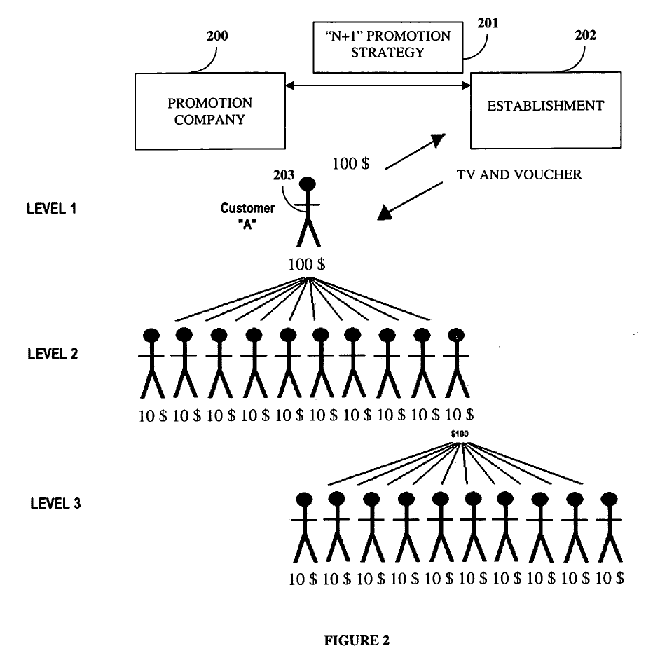

For illustration purposes of the customer incentive scheme, consider an establishment 202, for example, a company “X”, promoting a product, for example a television (TV) set. The customer incentive scheme also referred to as the “N+1” promotion strategy 201 is exemplarily illustrated in FIG. 2. The company “X” decides to use the “N+1” promotion strategy 201 to promote the TV set. The “N+1” promotion strategy 201 may be provided to the company “X” by a promotion company 200, for example, a company “Z”. Consider, the company “X” sells the TV set to a customer “A”. The customer “A” pays 100 dollars for the TV set. The company “X” provides a redeemable voucher along with the TV set to the customer “A”. The company “X” provides the customer “A” with a voucher worth, for example, 10 dollars, upon purchase of the TV set.

Upon receiving 100 dollars from the customer “A” on sale of the TV set, company “X” retains 90 dollars and provides the company “Z”, the remaining 10 dollars. Further, “N” other customers, for example, ten customers are provided 10 dollar vouchers upon purchase of products from the company “X”. In the “N+1” promotion strategy 201, “N” is the number of customers in the promotion cycle and may have a predetermined value. For example, “N” may have values 7, 20, 25, 100 etc. determined by the promotion company 200. Since, ten customers are provided 10 dollar vouchers, “N” has a value “10” in the “N+1” promotion strategy 201. The total value accumulated by the customer “A” is equal to the initial value on the redeemable voucher multiplied by the number of customers in the promotion cycle. The total value is 100 dollars, since the initial value on the coupon, 10 dollars, multiplied by the value of “N”, 10, equals to 100.

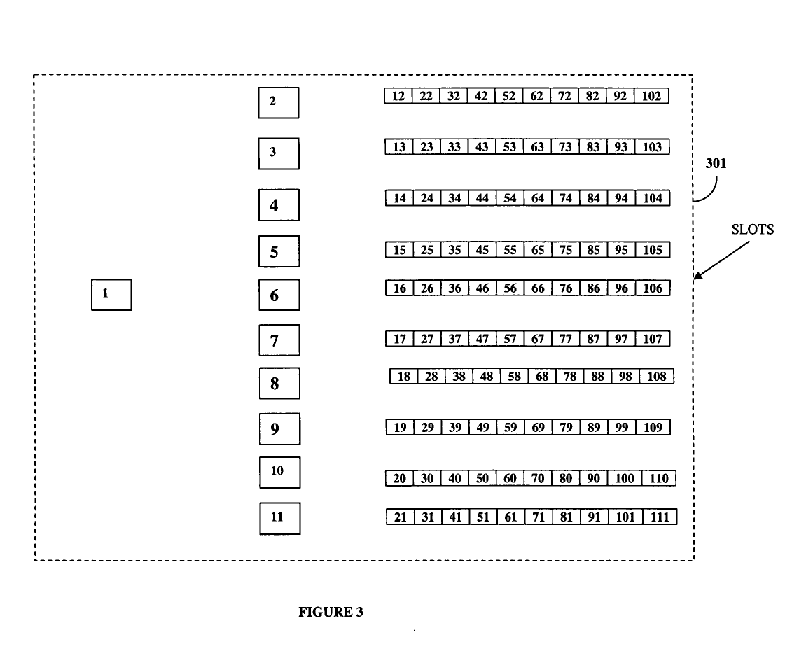

Upon receiving the 10 dollar vouchers, the customers including the customer “A”, registers on an online website 500 to participate in the promotion cycle provided by the company “Z”. The company “Z” places the participants including customer “A” in the promotion cycle hosted on the online website 500. The participants are assigned a place in the promotion cycle in an equally distributed manner. The promotion cycle is exemplarily illustrated in FIG. 3. The promotion company 200 assigns slots 301 to the participants. The allocation of the slots 301 is based on a logical sequence and is not based on luck, chance, or probability. Consider an example where the promotion company 200 places a participant in a second slot. The participants joining the promotion cycle, after the participant in the second slot, are placed from the third slot onwards. The promotion company 200 then places the twelfth participant under the second slot of the first participant, the thirteenth participant under the third slot of the third participant, and places the subsequent participants until the hundred and eleventh participant is placed under the eleventh slot of the eleventh participant as illustrated in FIG. 3.

The aforementioned placing of participants in an equally distributed manner enables the participants to redeem the vouchers without having to wait for a long period after the preceding participant has redeemed the voucher. Consider, for example, the participant placed in the second slot redeems the voucher after the hundred and second participant has been placed in the slot. Then the participant in the third slot may redeem the voucher once the hundred and third participant is placed in the slot, thereby enabling the participant in the third slot to redeem the voucher in a short period after the participant in the second slot has redeemed the voucher.

The customer “A” receives a voucher of 100 dollars and redeems the 100 dollar voucher for a product from the company “X” or the participating companies. The company “X” may also exchange the 100 dollar voucher of the customer “A” with the company “Z” for 100 dollars. The company “Z” may in turn charge company “X” and customer “A” for the services provided. Hence, by redeeming the voucher provided by the “N+1” promotion strategy 201, the purchasing power of the customer “A” is increased. Moreover, the company “X” benefits through the increased sale of products. Furthermore, the company “Z” benefits through the service charges levied on the company “X” and the customer “A” for the services offered.

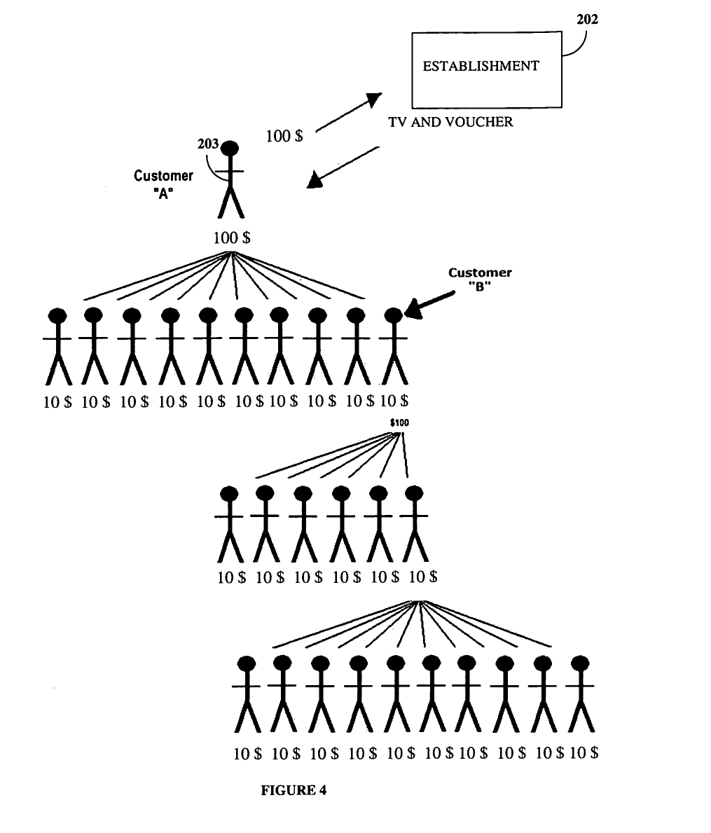

The method disclosed herein further allows the customer 203 to withdraw from the promotion cycle prior to completion of the promotion cycle. An “early withdraw option” provided to the customer 203 in the customer incentive scheme is exemplarily illustrated in FIG. 4. Consider a customer “B” participating in the “N+1” promotion strategy 201. Consider, ten other customers are participating in the “N+1” promotion strategy 201. The customer “B” logs into the online website 500 to determine the position in the promotion cycle. The customer “B” finds that six participants after the customer “B” have been allocated slots 301 and four more participants out of the ten participants are needed for the customer “B” to complete the promotion cycle. The customer “B” may then decide to withdraw from the promotion cycle. The customer “B” may decide to accept only 60 dollars and forego 40 dollars out of the 100 dollars. If the customer “B” withdraws from the “N+1” promotion strategy 201, the promotion company 200 may charge the customer “B” an early withdrawal fee. The customer “B” may redeem the redeemable voucher for a depreciated value determined by the promotion company 200. The depreciated value may be determined based on the early withdrawal fee and the customer service fee. In the aforementioned example, the customer “B” receives 60 dollars minus the early withdrawal fee and the customer service fee. In the aforementioned example, the withdrawal of the customer “B” does not affect the remaining participants of the promotion cycle.

The promotion company 200 also generates a customer registration report and provides the customer registration report to the establishment 202. The customer registration report includes information on number of customers registered on the online website 500. Further, the establishment 202 generates a sales analysis report and provides the sales analysis report to the promotion company 200. The sales analysis report provides information on quantity of merchandise sold based on the “N+1” promotion strategy 201. The customer registration report and the sales analysis report enable the establishment 202 and the promotion company 200 to determine any financial loss in the “N+1” promotion strategy 201. In the aforementioned example illustrated in FIG. 2, if the customer 203 does not register on the online website 500 and participate in the “N+1” promotion strategy 201, then the establishment 202 receives back the 10 dollars paid to the promotion company 200. The promotion company 200 may further charge the establishment 202 an administration fee for the services provided.

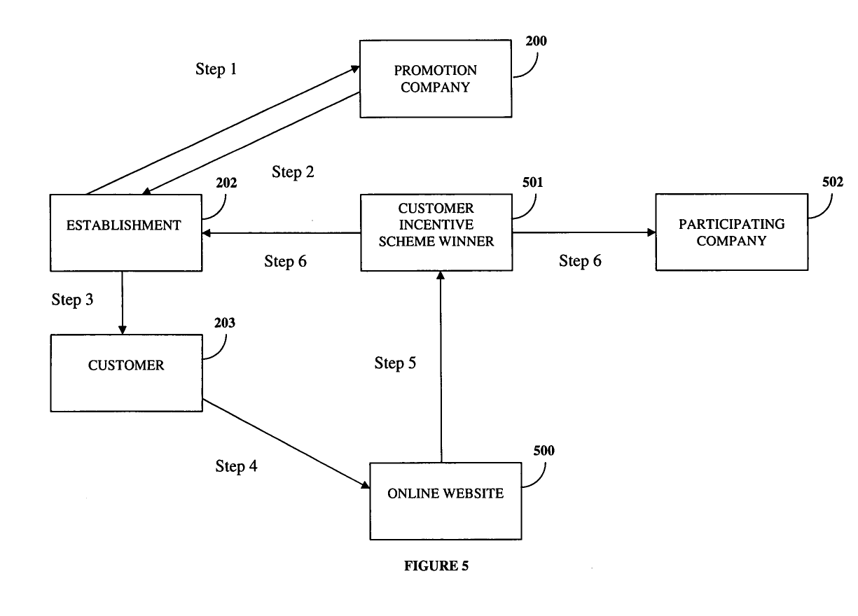

FIG. 5 exemplarily illustrates the process flow of the promotion of sales through the customer incentive scheme of the establishment 202. In “Step 1” of the process flow, the establishment 202 signs a contract with the promotion company 200, in order to enroll one or more products of the establishment 202 in the customer incentive scheme. “Step 2” of the process flow involves incorporating the establishment 202 into the promotion company's 200 network of clients and enabling the establishment 202 to issue redeemable vouchers to the customers as a part of the customer incentive scheme. In “Step 3” of the process flow, the establishment 202 sells the product and issues a redeemable voucher of a first value to a customer 203. In “Step 4” of the process flow, the customer 203 registers the redeemable voucher in a promotion cycle on an online website 500. At the completion of the promotion cycle, a voucher of a higher value in comparison to the first value of the voucher is won by the customer 203. The “Step 5” of the process flow involves notifying the customer incentive scheme winner 501 upon winning the voucher of higher value. The customer 203 may be notified through electronic mail (email), post, or by phone. In “Step 6” of the process flow, the customer 203 redeems the redeemable voucher for merchandise from the establishment 202 or a participating company 502 of the customer incentive scheme.

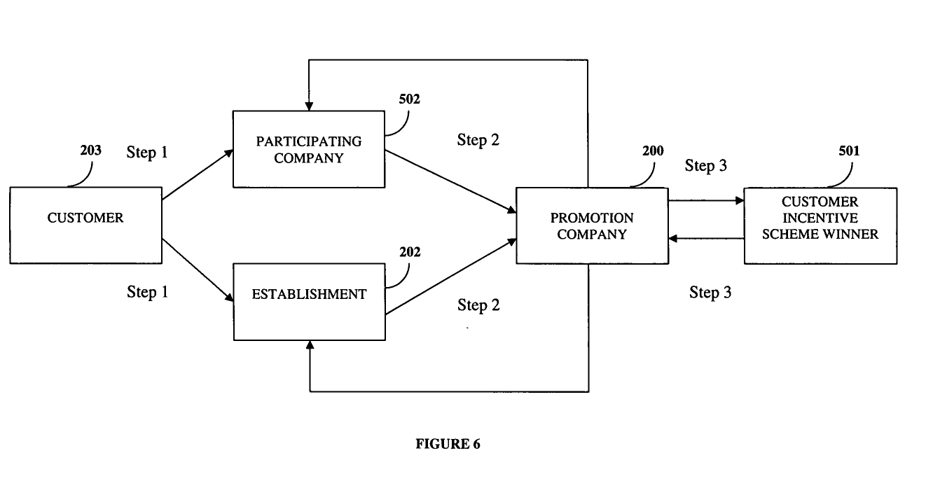

FIG. 6 exemplarily illustrates the monetary transaction flow in the customer incentive scheme. In “Step 1” of the monetary transaction flow, the customer 203 pays money to the establishment 202 or a participating company 502 in a customer incentive scheme for buying a product or service. In “Step 2” of the monetary transaction flow, the establishment 202 or the participating company pays, for example, 10 percent of the money received from the customer 203 to the promotion company 200. Further, the promotion company 200 may charge a service fee from the establishment 202 or the participating company 502. In “Step 3” of the monetary transaction flow, the customer incentive scheme winner 501 pays a service fee to the promotion company 200 upon winning the voucher of higher value. The service fee may be for example, between 4 percent and 15 percent of the purchased merchandise cost. Further, the customer 203 may pay the service fee and utilize 100 percent of the redeemable voucher value for exchanging with merchandise or may deduce the service fee from the redeemable voucher value and exchange for merchandise. The establishment 202 or the participating company 502 redeems the redeemed voucher in exchange for money from the promotion company 200.

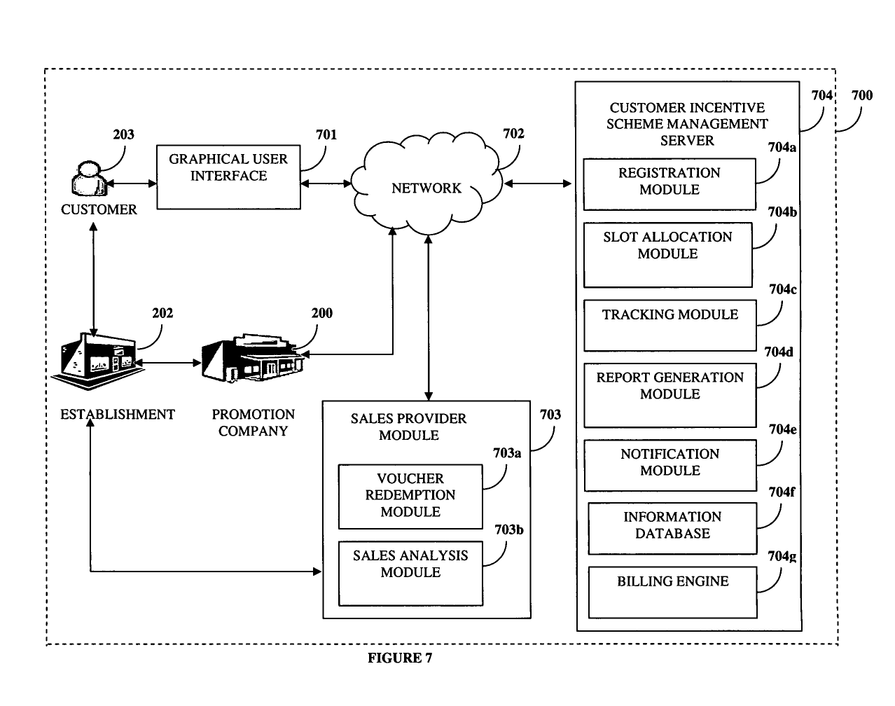

FIG. 7 illustrates a computer implemented system 700 for promoting sales through a customer incentive scheme of an establishment 202. The computer implemented system 700 disclosed comprises a sales provider module 703, a customer incentive scheme management server 704, and a graphical user interface 701 connected via a network 702. The customer incentive scheme management server 704 comprises a registration module 704a, a slot allocation module 704b, a tracking module 704c, a report generation module 704d, a notification module 704e, an information database 704f, and a billing engine 704g. The establishment 202 offers the customer 203 a redeemable voucher on purchase of merchandise. The customer 203 registers on an online website 500 hosted by the customer incentive scheme management server 704. The graphical user interface 701 enables the customer 203 to register the redeemable voucher on the online website 500 using the registration module 704a.

The slot allocation module 704b places the customer 203 in a promotion cycle of the promotion company 200. Further, the slot allocation module 704b determines a predetermined sequence of redeeming registered vouchers of the customer 203 and a plurality of registered customers. The tracking module 704c calculates and tracks total value accumulated by the customer 203 on the online website 500 till the total value reaches an exchange value predetermined by the establishment 202 and the promotion company 200. The total value is the sum of first values of registered vouchers of the plurality of registered customers. The report generation module 704d generates a customer registration report. The customer registration report comprises information on number of customers registered on the online website 500.The promotion company 200 provides the customer registration report to the establishment 202.

The notification module 704e notifies the customer 203 to redeem the redeemable voucher on completion of the promotion cycle. The information database 704f stores information of customers registered on the online website 500, information of redeemable vouchers, customer registration reports, and sales analysis reports. The billing engine 704g charges the establishment 202 a scheme service fee and the customer 203 a customer service fee. Further, the billing engine 704g deducts the customer service fee from the exchange value of the redeemable voucher. The sales provider module 703 comprises a voucher redemption module 703a and a sales analysis module 703b. The voucher redemption module 703a enables the customer 203 to redeem the redeemable voucher for the exchange value. The sales analysis module 703b analyzes sale of merchandise for the establishment 202. The sales analysis module 703b generates a sales analysis report based on the analysis. The sales analysis report provides information on quantity of merchandise sold based on the customer incentive scheme. The establishment 202 provides the sales analysis report to the promotion company 200. The customer registration report and the sales analysis report enable the establishment 202 and the promotion company 200 to determine any financial loss. Therefore, the method and system disclosed herein increases the purchasing power of the customer 203 and sale of merchandise of the establishment 202, thereby promoting sales of the establishment 202.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 704f, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of promoting sales through a customer incentive scheme of an establishment, comprising the steps of:
offering a customer a redeemable voucher of a first value by said establishment on purchase of merchandise through said customer incentive scheme of the establishment;
registering said redeemable voucher by said customer on an online website, wherein said online website is managed by a promotion company;
placing the customer in a promotion cycle by said promotion company, wherein said promotion cycle comprises a predetermined sequence of redeeming registered vouchers of the customer and a plurality of registered customers;
tracking total value accumulated by the customer on the online website till said total value reaches an exchange value predetermined by the establishment and the promotion company, wherein the total value is the sum of first values of said registered vouchers of said registered customers; and
redeeming the redeemable voucher by the customer for said exchange value, wherein the redeemable voucher is exchanged for merchandise;
whereby the customer incentive scheme increases purchasing power of the customer and sale of merchandise of the establishment, thereby promoting sales of the establishment.

2. The computer implemented method of claim 1, wherein the establishment is one or more of companies, shops, retail stores, service providers, online stores, and restaurants.

3. The computer implemented method of claim 1, further comprising a step of charging the establishment a scheme service fee by the promotion company.

4. The computer implemented method of claim 1, further comprising a step of charging the customer a customer service fee by the promotion company.

5. The computer implemented method of claim 4, wherein said customer service fee is deducted from the exchange value of the redeemable voucher, wherein the customer redeems the redeemable voucher for said deducted exchange value for merchandise.

6. The computer implemented method of claim 1, further comprising a step of allowing the customer to withdraw from the promotion cycle prior to completion of the promotion cycle.

7. The computer implemented method of claim 1, further comprising a step of generating a customer registration report by the promotion company, wherein said customer registration report comprises information on number of customers registered on the online website.

8. The computer implemented method of claim 1, further comprising a step of generating a sales analysis report by the establishment, wherein said sales analysis report comprises information on quantity of merchandise sold based on the customer incentive scheme.

9. The computer implemented method of claim 1, wherein the redeemable voucher includes a voucher number, website address of the promotion company, said first value, the exchange value upon completion of the promotion cycle, a predetermined value of the fee charged by the promotion company, promotion cycle instructions to the customer, and advertisements.

10. The computer implemented method of claim 1, wherein the customer redeems the redeemable voucher at one of the establishment and companies participating in the customer incentive scheme.

11. A computer implemented system for promoting sales through a customer incentive scheme of an establishment, comprising:
a customer incentive scheme management server, comprising:
a registration module for registering a redeemable voucher on an online website of a promotion company by a customer;
a slot allocation module for placing said customer in a promotion cycle by said promotion company;
a tracking module for tracking total value accumulated by the customer on said online website till said total value reaches an exchange value predetermined by said establishment and the promotion company; and
a voucher redemption module for redeeming said redeemable voucher by the customer for said exchange value.

12. The computer implemented system of claim 11, further comprising a graphical user interface for enabling the customer to register the redeemable voucher on the online website.

13. The computer implemented system of claim 11, further comprising a sales analysis module for analyzing sale of merchandise by the establishment.

14. The computer implemented system of claim 13, wherein said sales analysis module generates a sales analysis report for said analysis of said sale.

15. The computer implemented system of claim 11, wherein said slot allocation module determines a sequence of redeeming registered vouchers of the customer and a plurality of registered customers.

16. The computer implemented system of claim 11, wherein said tracking module calculates and tracks the total value accumulated by the customer, wherein the total value is the sum of first values of registered vouchers of a plurality of registered customers.

17. The computer implemented system of claim 11, wherein said customer incentive scheme management server further comprises a report generation module for generating a customer registration report, wherein said customer registration report comprises information on number of customers registered on the online website.

18. The computer implemented system of claim 11, further comprising an information database for storing information of customers registered on the online website, information of redeemable vouchers, customer registration reports, and sales analysis reports.

19. The computer implemented system of claim 11, wherein said customer incentive scheme management server further comprises a notification module for notifying the customer to redeem the redeemable voucher.

20. The computer implemented system of claim 11, wherein said customer incentive scheme management server further comprises a billing engine for charging the establishment a scheme service fee and the customer a customer service fee by the promotion company.

21. The computer implemented system of claim 20, wherein said billing engine deducts said customer service fee from the exchange value of the redeemable voucher.

22. A computer program product comprising computer executable instructions embodied in a computer-readable medium, wherein said computer program product comprises:
a first computer parsable program code for registering a redeemable voucher by a customer on an online website managed by a promotion company;
a second computer parsable program code for determining a sequence of redeeming registered vouchers of said customer and a plurality of registered customers;
a third computer parsable program code for tracking total value accumulated by the customer on said online website till said total value reaches an exchange value predetermined by an establishment and said promotion company; and
a fourth computer parsable program code for notifying the customer to redeem the voucher.
